(19) United States
(12) Patent Application Publication
(10) Pub. No.: US 2022/0284452 A1
(43) Pub. Date: Sep. 8, 2022

(54) ENTITY FUNCTIONAL AREA AND PRODUCT USE IDENTIFICATION

(71) Applicant: HG Insights, Inc., Santa Barbara, CA (US)

(72) Inventors: Robert J. Fox, Santa Barbara, CA (US); Abhinav Kaitha, Santa Barbara, CA (US)

(21) Appl. No.: 17/193,992

(22) Filed: Mar. 5, 2021

(51) Int. Cl. G06Q 30/02; G06N 20/00; G06N 5/04; G06F 16/93

(52) U.S. Cl. CPC G06Q 30/0201; G06N 20/00; G06N 5/04; G06F 16/93

(57) ABSTRACT

Entity functional area and product use identification implementations are described that identify functional areas of an entity and products used by these functional areas. In general, this involves generating a functional area classifier to identify one or more functional areas of the entity inferred in a document, identifying one or more product names found in the document, identifying an entity name in the document (if not already known), and establishing at least one combination of the entity name, the functional area, and a product name for each product name found in the document. In some implementations, at least one of the entity location or the vendor of the named product or the technology designation of the product, is identified in the document and included in the combinations. Multiple documents are processed, and the resulting established combinations are output.

### BACKGROUND

Advertisers, product manufacturers and technology vendors continually seek ways to identify potential customers who may purchase their products in the near future. This allows these entities to better target potential customers. The better the method of identifying these customers, the better the results. For example, blanket advertisements and blind contacts are less efficient, more costly and often less effective than targeted advertisements to potential customer who are believed to have an interest in purchasing a product. Ultimately, having knowledge of who is more likely to buy a product leads to more sales.

### SUMMARY

Identifying functional areas of an entity and products used by the functional areas (entity functional area and product use identification for short) is realized in implementations described herein. One general implementation takes the form of a system that includes an entity functional area and product use identifier having one or more computing devices, and an entity functional area and product use identification computer program having a plurality of sub-programs executable by the computing device or devices. The sub-programs configure the computing device or devices to access documents that are likely to infer an entity's functional areas and list the products the functional areas employ. Then, for each document accessed, a functional area classifier is employed to identify one or more functional areas of the entity inferred in the document, a product name identifier is employed to identity one or more product names found in the document, and at least one entity name-functional area-product name combination is established for each product name found in the document. A listing of the established entity name-functional area-product name combinations is then output.

In another exemplary implementation of the entity functional area and product use identification system includes an entity functional area and product use identifier having one or more computing devices, and an entity functional area and product use identification computer program having a plurality of sub-programs executable by the computing device or devices. The sub-programs configure the computing device or devices to access documents that are likely to infer an entity's functional areas and list the products the functional areas employ. Then, for each document accessed, an entity name identifier is employed to identity an entity name in the document, a functional area classifier is employed to identify one or more functional areas of the entity inferred in the document, and a product name identifier is employed to identity one or more product names found in the document. In addition, for each document accessed, the system employs at least one of an entity location identifier to identify a location associated with the entity name, or a vendor identifier to identify a vendor associated with each product name identified, or a technology designator identifier to identify a technology designation associated with each product name identified. Combinations of the entity name, functional area, product name, and at least one of the entity location or the vendor of the named product or the technology designation of the named product are then established for each document accessed, and a listing of the established combinations is output.

Another general implementation takes the form of a computer-implemented process for identifying functional areas of an entity and products used by the functional areas. This process uses one or more computing devices to perform a number of process actions. If a plurality of computing devices is employed, the computing devices are in communication with each other via a computer network. A first of the process actions involves accessing documents that are likely to infer an entity's functional areas and list the products the functional areas employ. Then, for each document accessed, a functional area classifier process action identifies one or more functional area of the entity inferred in the document, a product name identifier process action identifies one or more product names found in the document, and an establishment process action establishes at least one entity name-functional area-product name combination for each product name found in the document. A listing process action then outputs the established entity name-functional area-product name combinations.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the entity functional area and product use identification implementations described herein will become better understood with regard to the following description, appended claims, and accompanying drawings where:

FIG. 1 is a diagram illustrating one implementation, in simplified form, of a system framework for realizing the entity functional area and product use identification implementations described herein.

FIG. 2 is a diagram illustrating one implementation, in simplified form, of sub-programs included in the entity functional area and product use identification computer program.

FIG. 3 is a diagram depicting an exemplary job title and associated job description.

FIGS. 4A and 4B are diagrams depicting in FIG. 4A an example output in spread sheet format of separate lines for each entity name-functional area-product name combination found in input documents, and depicting in FIG. 4B. an example output in spread sheet format of an entity and functional area percentage breakdown for a product.

FIG. 5 is a diagram illustrating another implementation, in simplified form, of sub-programs for identifying co-dependent product relationships.

FIG. 6 is a diagram illustrating one implementation, in simplified form, of sub-programs for calculating product usage percentages.

FIG. 7 is a diagram illustrating one implementation, in simplified form, of sub-programs for calculating average product usage percentages.

FIG. 8 is a diagram illustrating one implementation, in simplified form, of sub-programs for calculating entity-wide product usage percentages.

FIG. 9 is a diagram illustrating one implementation, in simplified form, of sub-programs for calculating average entity-wide product usage percentages.

FIG. 10 is a flow diagram illustrating an exemplary implementation, in simplified form, of a process for realizing the entity functional area and product use identification implementations described herein.

FIG. 11 is a diagram illustrating one implementation, in simplified form, of sub-programs included in the entity functional area and product use identification computer program that includes optional sub-programs for identifying entity location, or identifying a product vendor, or identifying a technology designator in documents.

FIG. 12 is a diagram illustrating one implementation, in simplified form, of sub-programs for calculating technology adoption percentages.

FIG. 13 is a diagram illustrating one implementation, in simplified form, of sub-programs for outputting combinations for a prescribed time period where documents input into the entity functional area and product use identification computer program have dates associated therewith that fall within the particular time period.

FIG. 14 is a diagram illustrating one implementation, in simplified form, of sub-programs for estimating the number of new hires.

FIG. 15 is a diagram illustrating one implementation, in simplified form, of sub-programs for estimating the number of employees.

FIG. 16 is a diagram illustrating a simplified example of a general-purpose computer system on which various implementations and elements of the entity functional area and product use identification, as described herein, may be realized.

### DETAILED DESCRIPTION

In the following description of entity functional area and product use identification implementations reference is made to the accompanying drawings which form a part hereof, and in which are shown, by way of illustration, specific implementations in which the entity functional area and product use identification can be practiced. It is understood that other implementations can be utilized and structural changes can be made without departing from the scope of the entity functional area and product use identification implementations.

It is also noted that for the sake of clarity specific terminology will be resorted to in describing the entity functional area and product use identification implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “some implementations”, or “one tested implementation”; or “one version”, or “another version”, or an “exemplary version”, or an “alternate version”, or “some versions”, or “one tested version”; or “one variant”, or “another variant”, or an “exemplary variant”, or an “alternate variant”, or “some variants”, or “one tested variant”; means that a particular feature, a particular structure, or particular characteristics described in connection with the implementation/version/variant can be included in one or more implementations of the entity functional area and product use identification. The appearances of the phrases “in one implementation”, “in another implementation”, “in an exemplary implementation”, “in an alternate implementation”, “in some implementations”, “in one tested implementation”; “in one version”, “in another version”, “in an exemplary version”, “in an alternate version”, “in some versions”, “in one tested version”; “in one variant”, “in another variant”, “in an exemplary variant”, “in an alternate variant”, “in some variants” and “in one tested variant”; in various places in the specification are not necessarily all referring to the same implementation/version/variant, nor are separate or alternative implementations/versions/variants mutually exclusive of other implementations/versions/variants. Yet furthermore, the order of process flow representing one or more implementations, or versions, or variants of the entity functional area and product use identification does not inherently indicate any particular order nor imply any limitations thereto.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” and variants thereof, and other similar words are used in either this detailed description or the claims, these terms are intended to be inclusive, in a manner similar to the term “comprising”, as an open transition word without precluding any additional or other elements.

### 1.0 Identifying Functional Areas of an Entity and the Products Used

Entity functional area and product use identification implementations that are described herein identify functional areas of an entity and products used by these functional areas. This information can be advantageously used in various implementations to analyze product and technology distribution across entities and industries. Knowing the technology distribution across an entity would allow the entity to identify shortfalls and to develop purchasing plans. Knowing the technology distribution across entities would also facilitate a marketer to identify marketing opportunities. For instance, if it is known that a particular functional area of an entity is not using a marketer's product or is currently using a competitor's product, marketing efforts can be targeted to that functional area of the entity. In general, identifying functional areas of an entity and products used involves generating a functional area classifier component, identifying product names, identifying entity names (if not already known), and outputting entity-functional area-product combinations.

For the purposes of this description an entity refers to a natural entity such as an individual person; a business entity such as an association, corporation, partnership, company, proprietorship, or trust; or a governmental entity such as a university or institute; among others. Also, for the purposes of this description, a functional area of an entity refers to a department, group, team, branch, division, unit, section, or any other sub-part of an entity. For example, some common functional areas of a business entity include Finance, Operations, Human Resources, Sales, Administration, IT, Supply, Customer Success or Service, Engineering, Marketing, Management, and Science, among others. Still further, for the purposes of this description, a product refers to a tangible or intangible, commercially or non-commercially available, product or service. Thus, for example, computer software can be deemed a product of a software company and investment advice can be deemed a product of a brokerage company.

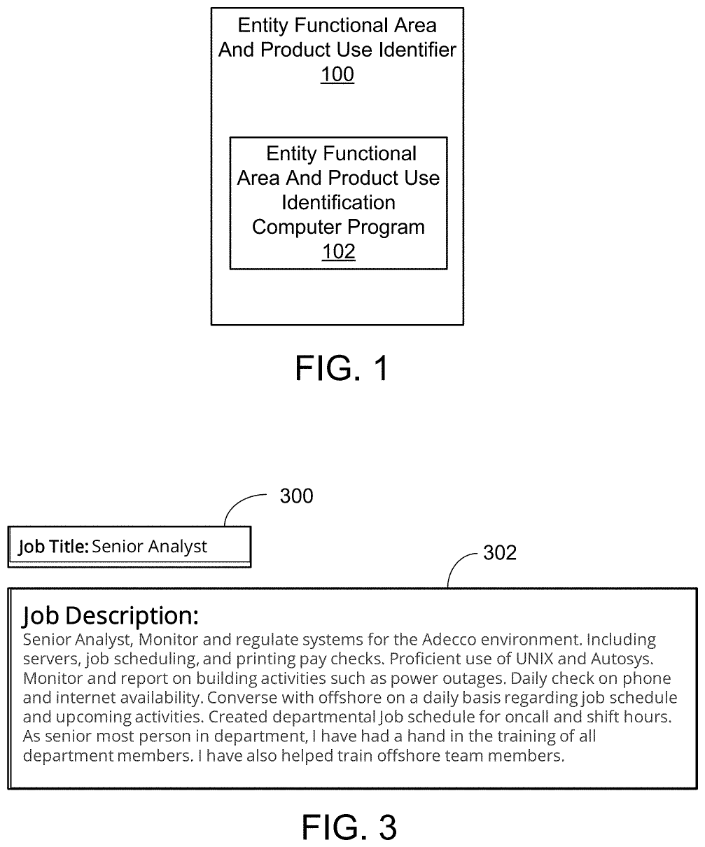

In view of the foregoing, FIG. 1 illustrates one implementation, in simplified form, of a system framework for identifying functional areas of an entity and products used by the functional areas. As exemplified in FIG. 1, the system framework includes an entity functional area and product use identifier including one or more computing devices 100, and an entity functional area and product use identification computer program 102 having a plurality of sub-programs executable by the computing device or devices of the identifier.

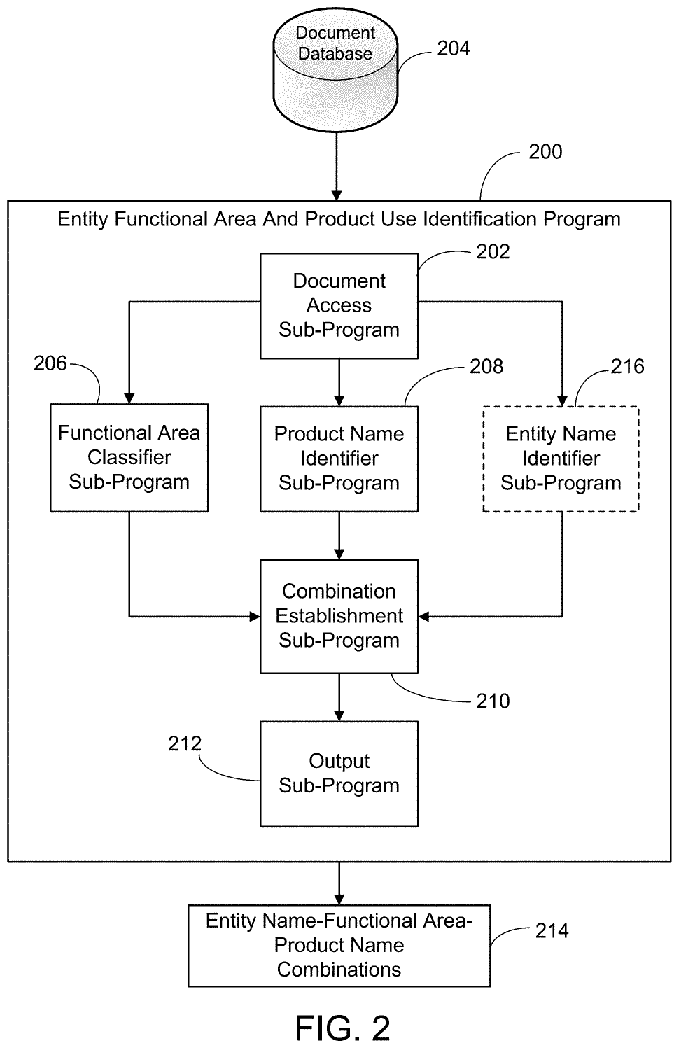

FIG. 2 illustrates one implementation, in simplified form, of sub-programs included in the entity functional area and product use identification computer program 200 that configure the aforementioned computing device or devices. More particularly, a document access sub-program 202 is included as shown in FIG. 2. The document access sub-program 202 accesses documents that are likely to infer an entity's functional areas and list the products the functional areas employ from a document database 204. In one implementation, the document database 204 is a database of job listings that include job titles and job descriptions. In another implementation, the document database 204 is a database of job resumes that include job titles and job descriptions. In yet another implementation, the document database 204 is a combination of job listings and job resumes. The entity functional area and product use identification computer program 200 also includes a functional area classifier sub-program 206. The functional area classifier sub-program 206 is used, for each document accessed, to identify a functional area of the entity that is inferred in the document. The computer program 200 further includes a product name identifier sub-program 208 that is used, for each document accessed, to identify one or more product names found in the document, and a combination establishment sub-program 210 that, for each accessed document, establishes an entity name-functional area-product name combination for each product name found in the document. An output sub-program 212 is also included in the entity functional area and product use identification computer program 200 to output a listing of the established entity name-functional area-product name combinations 214. The foregoing sub-programs will be described in more detail in the sections to follow.

### 1.1 Functional Area Classifier

The entity functional area and product use identification implementations described herein include a functional area classifier to identify a functional area of the entity inferred in a document. In one implementation, the functional area classifier is generated using supervised machine learning (SML) techniques. For example, in one version, the SML technique employed is fastText. However, it is not intended to limit the entity functional area and product use identification implementations described herein to just this technique as other supervised machine learning techniques could be used instead. In general, supervised machine learning involves generating a function that maps an input to an output based on a plurality of example input-output training pairs. More particularly, a supervised learning algorithm analyzes a training data set and produces an inferring function, which can be used for mapping new examples. Thus, in the case of the functional area classifier, once trained the classifier includes a functional area inferring function that identifies a functional area based on an input document. While a SML technique can be used to identify a single functional for each document, this need not be the case. Various SML techniques (including fastText) assign probabilities to each functional area which in total add up to 100 percent. For example, a SML technique may determine that a document has an 70% probability that it infers a marketing functional area, a 20% probability it infers a sales functional area, a 5% possibility that it infers an engineering functional area, and smaller probabilities it infers other functional areas. In one implementation, the functional area or areas attributed to a document is determined by first selecting the top three functional areas based on their probabilities. Thus, in the foregoing example, the marketing, sales and engineering functional areas would be selected as candidate functional areas for the document. Next, a thresholding criterion is applied. In one version, if any one of the functional areas has a probability that equals or exceeds 60%, it is chosen as the sole functional area inferred by the document. In the foregoing example, the marketing functional area would be associated with the document. However, suppose none of the functional area probabilities equal or exceed 60%. For example, suppose the SML technique determines that a document has an 50% probability that it infers a sales functional area, a 40% probability it infers a marketing functional area, a 5% possibility that it infers an engineering functional area, and smaller probabilities it infers other functional areas. In one version, rather than choosing the functional area with the highest probability even though it is less than 60% (sales in the latter example), the functional areas having probabilities less than 60% but equal to or greater than 40% are identified as candidates. In one version, the top two functional areas according to their probabilities are chosen as the functional areas inferred by the document. In the latter example, this would include sales and marketing. If there are no functional areas having probabilities that equal or exceed 40%, then the document is not associated with a functional area and dropped from consideration in generating entity name-functional area-product name combinations. It is noted that the foregoing threshold values are intended to be exemplary. While it was found that these threshold values worked well for job resume and job listing documents, other threshold values can be employed instead without departing from the scope of the entity functional area and product use identification implementations described herein.

In general, the input data used to train the SML and used as new inputs is made up of the aforementioned documents that are believed to reference an entity's functional areas and the products an entity employs. For example, job listing and resume documents often include job titles and descriptions that infer an association to a particular functional area of an entity, and typically contain the names of products used by the entity. Take for instance, a job listing for a mechanical engineer that specifies a list of software programs an applicant needs to be proficient in to qualify for the position. An engineering position infers the job could be in the engineering department, which is a functional area of the entity, and the names of the software programs are product names.

In one implementation, a job title and its associated description in a job listing or resume document are extracted, combined, and employed to create the training data set used to train the functional area classifier. In one implementation, the job title and associated description are extracted as described in a concurrently filed, commonly owned U.S. patent application assigned Ser. No. 16/777,350 filed on Jan. 30, 2020 which is hereby incorporated by reference in its entirety. FIG. 3 depicts an exemplary job title 300 (Senior Analyst) and associated job description 302 that was extracted from a job listing document. The extracted job title and associated description are combined and preprocessed as required by the particular SML technique being employed to create the input part of an input-output training pair. For example, the preprocessing can be accomplished as described in the concurrently filed, commonly owned U.S. patent application assigned Ser. No. 16/777,350 filed on Jan. 30, 2020 which is hereby incorporated by reference in its entirety. The input part is labeled with a known functional area of an entity associated with the input. The label represents the output part of the input-output training pair. Multiple input-output training pairs are created in the same manner.

It is noted, however, the functional area classifier component is not limited to just SML techniques. In general, any machine learning technique, supervised or unsupervised (e.g., a neural network approach), can be employed to generate the functional area component of the functional area classifier. In one implementation, an unsupervised machine learning technique is trained to identify a functional area of the entity based on an input including a job title and job description combination derived from a job listing or a job resume document.

### 1.2 Product Name Identification

Another component of the entity functional area and product use identification implementations described herein identifies product names. This product name identifier identifies product names contained within the aforementioned documents. In one implementation, a product name identifier as described in US Patent Application Publication US 2020/0380540, which is hereby incorporated by reference in its entirety, is employed to identify product names in an appropriate document. For example, the product name identifier can identify product names in job listings and resumes.

It is also noted that the search for product names can be restricted to just those products of interest to reduce processing and analytical costs. For example, the products of interest could be limited to new products only or to those associated with a particular technology or industry.

### 1.3 Entity Name Identification Component

Yet another component of the entity functional area and product use identification implementations described herein identifies entity names whenever they are not already known. To this end, referring again to FIG. 2, an optional entity name identifier sub-program 216 (as indicated by the broken line box) is included that identifies entity names contained within the aforementioned documents, such as job listings and resumes. In one implementation, an entity name identifier as described in a concurrently filed, commonly owned U.S. patent application assigned Ser. No. 16/550,684 filed on Aug. 26, 2019, which is hereby incorporated by reference in its entirety, is employed to identify entity names in a document.

Additionally, for the purposes of this description, an entity can refer to a natural entity such as an individual person; a business entity such as an association, corporation, partnership, company, proprietorship, or trust; or a governmental entity such as a university or institute; among others. In one version, a uniform resource locator (URL) associated with the entity is used as its entity name.

### 1.4 Output

The entity functional area and product use identification implementations described herein also includes an output component. In one implementation, the output component simply reports the name of an entity, along with a functional area and a product associated with an input document. If more than one product is identified, the output report lists them as separate entity name-functional area-product name combinations. If multiple documents are input, a separate line is output for each entity name-functional area-product name combination that is formed from each input document. In implementations where more than one functional area is identified from a document as described previously, the output report lists each entity name-functional area-product name combination that can be formed from the entity name, functional areas and product name(s) identified from the document. More particularly, for each product identified in a document and each functional area inferred from a document, the results of the previously described supervised machine learning technique for all the documents not dropped from consideration is aggregated across all entities. For the product under consideration, the percentage of documents in the aggregation associated with that product and each of the functional areas under consideration is calculated. Once the percentages have been computed in this manner for the product and each functional area associated with the document being analyzed, it is first determined if any of the calculated percentages equals or exceeds 90%. If this is the case, the product and functional area involved in the 90% or more calculation is used in generating a single entity name-functional area-product name combination for the product under consideration in the document being analyzed even though the document may have another functional area associated with it as well. If, however, it is determined that none of the calculated percentages equals or exceeds 90%, then the highest percentages calculated for the product under consideration and each of the functional areas under consideration are added, if the percentage exceeds a minimum percentage threshold, until the sum equals or exceeds 90% or all the percentages exceeding the minimum percentage threshold have been added together. The product and the functional area involved in calculating each of the percentages added together are used in generating a separate entity name-functional area-product name combination for the product under consideration in the document being analyzed. In this way, one or more combinations is generated for each product identified in a document. It is noted that in one implementation, the minimum percentage threshold is established by dividing the integer 1 by the total number of functional areas involved in the analysis. For example, if there are 17 functional area being considered, the minimum percentage threshold would be 5.88%.

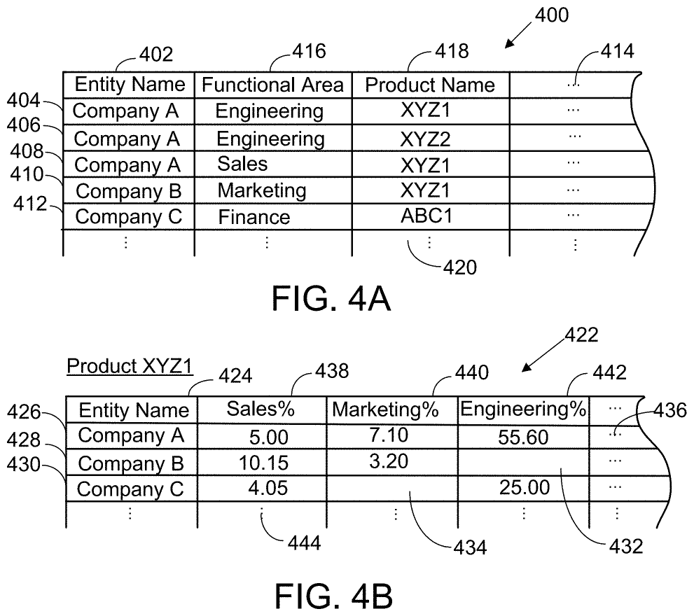

Referring to FIG. 4A, an example 400 of an output is illustrated. In this example output 400, three entities (Companies A, B and C) are shown in the Entity column 402. Company A has an Engineering functional area that uses a Product named XYZ1 (as seen in row 404) and a Product named XYZ2 (as seen in row 406). Company A also has a Sales functional area that uses Product XYZ1 (as seen in row 408). Company B has a Marketing functional area that uses Product XYZ1 (as seen in row 410), and Company C has a Finance functional area that uses a Product named ABC1 (as seen in row 412). The line of horizontal dots 414 at the end of each row indicates that there can be more columns in addition to the Entity Name column 402, Functional Area column 416 and Product Name column 418. These additional columns could list an entity location, or product vendor, or technology designation, among other items as will be described in more detail later. The line of vertical dots 420 at the bottom of each column indicate that more entity name-functional area-product name combinations can be listed. It is noted that the example output is in the form of a spread sheet or table. However, it is not intended to limit the form of the output to just spreadsheets and tables. In general, any format appropriate for presenting the listing of the entity name-functional area-product name combinations can be employed. Thus, the listing of the established entity name-functional area-product name combinations 214 of FIG. 2 can take the form of a spreadsheet or table as illustrated in the example of FIG. 4A.

### 1.5 Operation

In operation, the functional area classifier component (which has been trained using a machine learning technique as described previously and includes product name and optionally entity name components), is used to identify a functional area associated with an input, as well as the product and optionally entity names found in that input. The input represents documents that are believed to infer an entity's functional areas and the products an entity's functional areas employ. In one implementation, this involves generating an input by combining a job title and its associated description in a job listing or resume document and pre-processing the combination for entry into the functional area classifier in the same manner as described previously in connection with generating training inputs. The prepared input is then processed via the functional area classifier to identify a functional area of an entity associated with the input and the product names found in the input.

### 1.6 Co-Dependent Products

One useful insight that can be gleaned from the entity name-functional area-product name combination output derived from multiple inputs is the identification of co-dependent products within an entity's functional areas. In general, when the same products are seen to be used in a functional area of multiple entities, this can indicate a co-dependency relationship between the products. Thus, if the output shows that a particular entity's functional area is not using one or more products typically found to be used by the same functional area in other entities, then this can infer the particular entity may benefit from using the missing product or products.

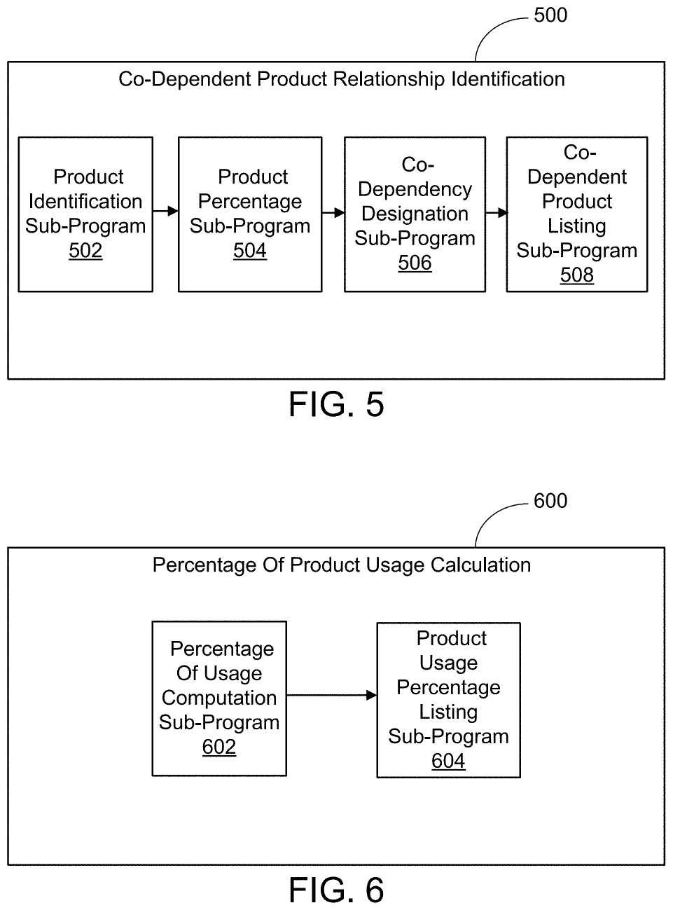

Referring to FIG. 5, in one implementation, the entity functional area and product use identification computer program 500 includes sub-programs to identify co-dependency relationships between products. More particularly, a product identification sub-program 502 is employed to identify the products used in the functional area for each functional area across all the entities found in the listing of the established entity name-functional area-product name combinations. A product percentage sub-program 504 is then used to identify products used in at least a prescribed percentage of the corresponding functional areas between the entities. Thus, for each corresponding functional area between the entities, only those products used in the prescribed percentage of the functional areas are identified. In a co-dependency designation sub-program 506, the identified products used in at least the prescribed percentage of the functional areas are then designated as co-dependent products. A co-dependent product listing sub-program 508 is then used to output a list of co-dependent products for each functional area found in the listing of the established entity name-functional area-product name combinations.

### 1.7 Product Usage Distribution

Another useful insight can be gleaned from analyzing the distribution of the product usage by functional area. This is useful in providing better resolution about who and potentially what a product is being used for in a functional area. To this end, in one implementation, the percentages of the usage of a product across the entity's functional areas are calculated. For example, it might be found that a particular software program is being used in many of the functional areas of an entity, but mostly in the customer success department. Knowing which functional area in an entity is a user of a product can infer what the product is being used for. For instance, if it is known that a software product can be used for different purposes such as managing employees or call logging, and it is being used by the customer success department, it can be inferred that the product is likely being used by the customer success department for call logging. If the human resources department is employing the product it could be inferred that it is likely being used for managing employees.

Referring to FIG. 6, in one implementation the entity functional area and product use identification computer program 600 includes sub-programs to calculate a percentage of usage for a product of interest. More particularly, in a percentage of usage computation sub-program 602, for each entity found in the listing of the established entity name-functional area-product name combinations and each listed functional area of the entity, a percentage of usage for a product listed in the functional area of the entity is computed. In one implementation, this computation involves dividing the summation of the number of entity name-functional area-product name combinations indicating the product is in use in the functional area by the summation of the number of entity name-functional area-product name combinations indicating the product is in use in any of the functional areas of the entity. A product usage percentage listing sub-program 604 is then used to output a list of the percentage of usage for the product for each listed functional area of the entity for each entity found in the listing of the established entity name-functional area-product name combinations. The procedure illustrated in FIG. 6 can be repeated for each different product of interest. Referring to FIG. 4B, an example output 422 for a Product named XYZ1 is shown. In this example, three entities (Companies A, B and C) are shown in the Entity column 424. Company A has a Sales functional area that uses 5.00% of Product XYZ1 employed by the entity, a Marketing functional area that uses 7.10% of Product XYZ1 employed by the entity, and an Engineering functional area that uses 55.60% of Product XYZ1 employed by the entity (as seen in row 426). Similar percentage breakdowns are shown for entities Company B and Company C in rows 428 and 430, respectively. Note that Company B has a blank cell 432 for its Engineering functional area and Company C has a blank cell 434 for its Marketing functional area. These blank cells indicate that the functional area involved does not employ product XYZ1. The line of horizontal dots 436 at the end of each row indicates that there can be more functional area columns in addition to the Sales column 438, Marketing column 440 and Engineering column 442. The line of vertical dots 444 at the bottom of each column indicates that more entity and functional area percentage breakdown rows can be listed. It is noted that the example output is in the form of a spreadsheet or table. However, it is not intended to limit the form of the output to just spreadsheets and tables. In general, any format appropriate for presenting the entity and functional area percentage breakdowns can be employed.

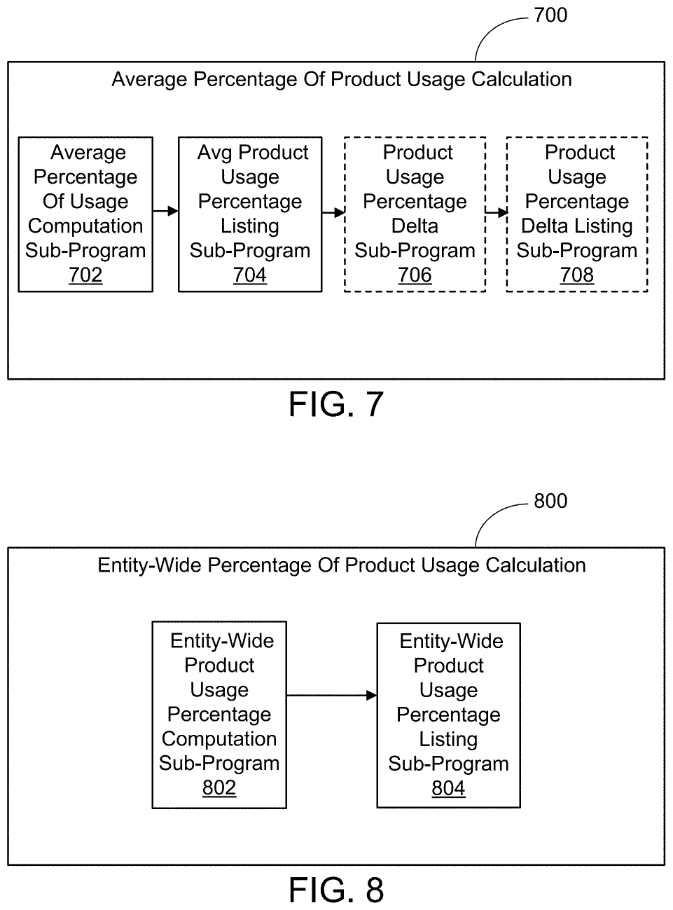

Further, if the percentages are calculated for multiple entities and then averaged across all the entities, this produces an average usage percentage for a product in each functional area. A particular entity's usage percentage can then be compared to the average to determine if an entity's product usage is above or below average. More particularly, referring to FIG. 7, in one implementation the entity functional area and product use identification computer program 700 includes sub-programs to calculate an average percentage of usage for a product of interest. First, in an average percentage of usage computation sub-program 702, for each functional area found in the listing of the established entity name-functional area-product name combinations, an average of the percentages of usage for a product listed in the functional area is computed across all the entities having the functional area. An average product usage percentage listing sub-program 704 is then used to output a list of the average of the percentages of usage for the product for each listed functional area for each entity found in the listing of the established entity name-functional area-product name combinations. In one optional version, the entity functional area and product use identification computer program 700 further includes a product usage percentage delta sub-program 706 that computes whether the percentage of usage for the product listed in a functional area is above, or the same as, or below the average of the percentages of usage for the product for the functional area across all the listed entities having that functional area. This computation is done for each listed entity found in the listing of the established entity name-functional area-product name combinations and each listed functional area of the entity. A product usage percentage delta listing sub-program 708 is then used to output a list of whether the percentage of usage for the product listed in the functional area is above, or the same as, or below the average of the percentages of usage for the product in the functional area. This is done for each functional area. It is noted that the optional nature of sub-programs 706 and 708 is illustrated in FIG. 7 by the use of broken line boxes. In addition, the procedure illustrated in FIG. 7 can be repeated for each different product of interest.

It is noted that a similar analysis can be done on an entity-wide basis by summing the number of output lines an entity has for a particular product regardless of the functional area. The average of the summations is calculated for the entities, and then compared to the summation of a particular entity to see if that entity's usage of the product is above or below average. Referring to FIG. 8, in one implementation the entity functional area and product use identification computer program 800 includes sub-programs to calculate an entity-wide percentage of usage for a product of interest. More particularly, in an entity-wide product usage percentage computation sub-program 802, for each entity found in the listing of the established entity name-functional area-product name combinations, a percentage of usage for a product listed in any of the functional areas of the entity is computed. In one implementation, this computation involves dividing the summation of the number of entity name-functional area-product name combinations indicating the product is in use in any functional area of the entity by the summation of the number of entity name-functional area-product name combinations indicating the product is in use in any of the functional areas of all the entities found in the listing of the established entity name-functional area-product name combinations. An entity-wide product usage percentage listing sub-program 804 is then used to output a list of the entity-wide percentage of usage for the product for each entity found in the listing of the established entity name-functional area-product name combinations. The procedure illustrated in FIG. 8 can be repeated for each different product of interest.

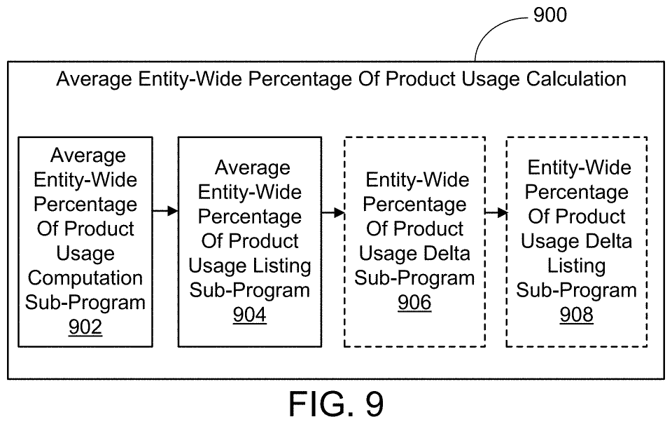

Further, if the entity-wide usage percentages are averaged across all the entities, this produces an average entity-wide percentage for a product. A particular entity's entity-wide usage percentage can then be compared to the average to determine if the entity's product usage is above or below average. More particularly, referring to FIG. 9, in one implementation the entity functional area and product use identification computer program 900 includes sub-programs to calculate an average entity-wide percentage of usage for a product of interest across all the entities listed in the entity functional area and product use identification computer program. First, in an average entity-wide percentage of product usage computation sub-program 902, an average of the percentages of usage for the product across all the listed entities in the listing of the established entity name-functional area-product name combinations is computed to produce an average entity-wide percentage of usage for a product. An average entity-wide percentage of product usage listing sub-program 904 is then used to output the average of the percentages of usage for the product across all the entities. In one optional version, the entity functional area and product use identification computer program 900 further includes an entity-wide percentage of product usage delta sub-program 906 that computes whether the entity-wide percentage of usage for the product is above, or the same as, or below the average of the entity-wide percentages of usage for the product across all the listed entities in the listing of the established entity name-functional area-product name combinations. This computation is done for each listed entity found in the listing of the established entity name-functional area-product name combinations. An entity-wide percentage of product usage delta listing sub-program 908 is then used to output a list of whether the entity-wide percentage of usage for the product is above, or the same as, or below the average of the entity-wide percentages of usage for the product. It is noted that the optional nature of sub-programs 906 and 908 is illustrated in FIG. 9 by the use of broken line boxes. In addition, the procedure illustrated in FIG. 9 can be repeated for each different product of interest.

### 1.8 Process for Identifying Functional Areas of an Entity and Products Used

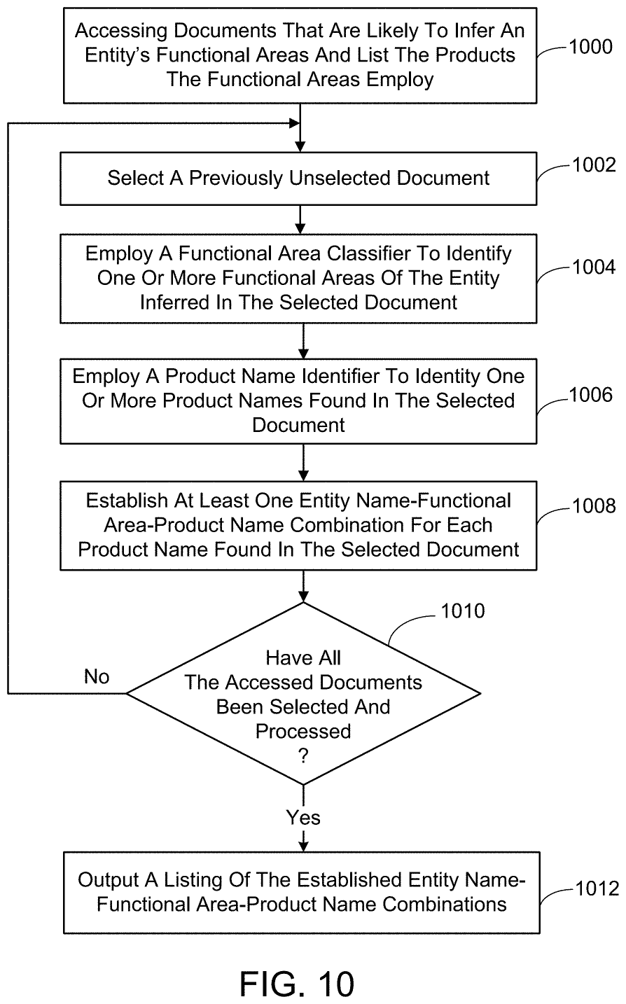

FIG. 10 illustrates an exemplary implementation, in simplified form, of a process for identifying functional areas of an entity and products used by the functional areas based on the above-described computer program as realized on the system framework 100 illustrated in FIG. 1. As exemplified in FIG. 10, the process starts with accessing documents that are likely to infer an entity's functional areas and list the products the functional areas employ (process action 1000). Next, a previously unselected document is selected (process action 1002). A functional area classifier is employed to identify a functional area of the entity inferred in the selected document (process action 1004), a product name identifier is employed to identity one or more product names found in the selected document (process action 1006), and an entity name-functional area-product name combination is established for each product name found in the selected document (process action 1008). It is then determined if all the accessed documents have been selected and processed (process action 1010). If not, process actions 1002 through 1010 are repeated. Otherwise, a listing of the established entity name-functional area-product name combinations is output (process action 1012).

### 2.0 Identifying Additional Items in the Documents

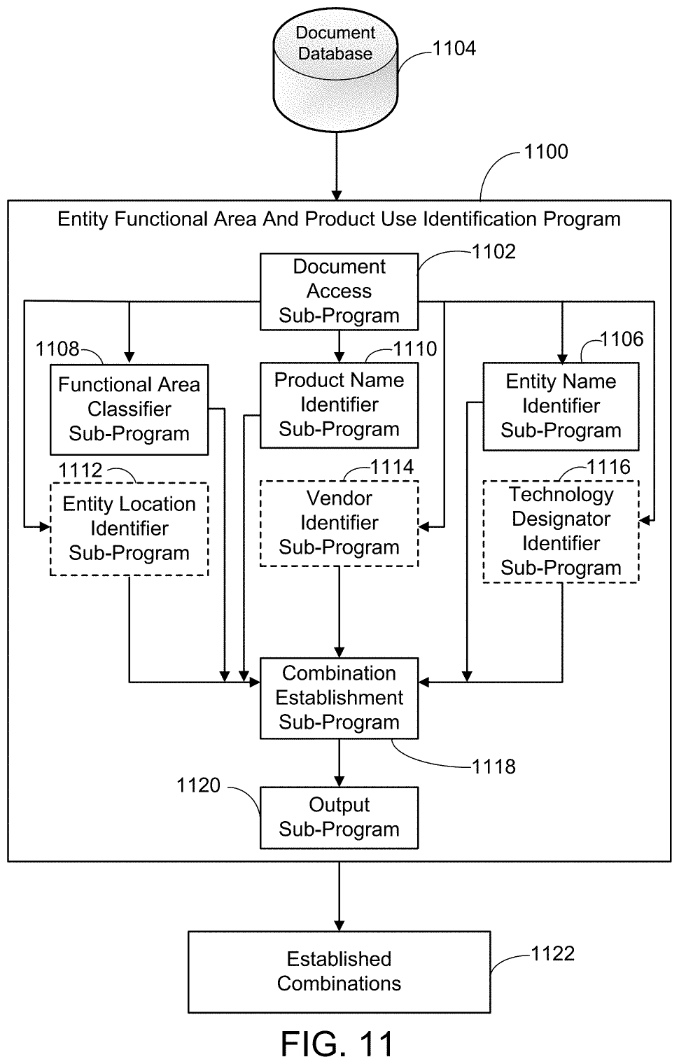

In various entity functional area and product use identification implementations described herein, addition items are extracted from the inputted documents, including at least one of an entity's location, or a vendor associated with a product found in the input, or a technology associated with the entity, or a date assigned to the input. More particularly, FIG. 11 illustrates one implementation, in simplified form, of sub-programs included in the entity functional area and product use identification computer program 1100 that configure the previously described computing device or devices. A document access sub-program 1102 is included as shown in FIG. 11. The document access sub-program 1102 accesses documents that are likely to infer an entity's functional areas and list the products the functional areas employ from a document database 1104. In one implementation, the document database 1104 is a database of job listings that include job titles and job descriptions. In another implementation, the document database 1104 is a database of job resumes that include job titles and job descriptions. In yet another implementation, the document database 1104 is a combination of job listings and job resumes. The entity functional area and product use identification computer program 1100 also includes an entity name identifier sub-program 1106 to identity an entity name for each document accessed and a functional area classifier sub-program 1108. The functional area classifier sub-program 1108 is used to, for each document accessed, identify a functional area of the entity that is inferred in the document. The computer program 1100 further includes a product name identifier sub-program 1110 that is used, for each document accessed, to identify one or more product names found in the document. The computer program 1100 additionally includes at least one of an entity location identifier sub-program 1112 to identify a location associated with the entity name, or a vendor identifier sub-program 1114 to identify a vendor associated with the product name(s) identified, or a technology designator identifier sub-program 1116 to identify a technology designation associated with the product name(s) identified. The optional nature of sub-programs 1112, 1114, 1116 is indicated in FIG. 11 by the use of broken line boxes. A combination establishment sub-program 1118 is included as well. For each document accessed, this sub-program 1118, establishes combinations of the entity name, functional area, product name, and at least one of the entity location or the vendor of the named product or the technology designation of the product. An output sub-program 1120 is also included in the entity functional area and product use identification computer program 1100 to output a listing of the established combinations 1122. In one implementation, the listing of the established combinations 1122 takes the form of a spreadsheet or table. However, it is not intended to limit the form of the output to just spreadsheets and tables. In general, any format appropriate for presenting the listing of the established combinations can be employed.

In one implementation where the additional item(s) extracted from the documents include an entity's location, the combinations output include a location element. This has the advantage of allowing the output to be sorted by entity and location so that products used by different functional areas at different locations associated with an entity are identified and can be contrasted and compared. This information can be used in several advantageous ways. For example, the information can be used to determine whether a product has been adopted entity-wide or just at particular locations. Location information is useful for more precise marketing. Just knowing that a particular functional area (e.g., Engineering) of an entity that has multiple locations employs a particular product or technology can waste resources if the functional area of interest is concentrated in one location. In other words, knowing that a particular functional area of an entity at a particular location is using a product or technology allows sales and marketing activities to be concentrated toward that location rather than entity-wide. It is noted that the entity location can be multifaceted in that it can include a city, or a state, or a country, or any combination of these places. In one implementation, an entity location identifier as described in a concurrently filed, commonly owned U.S. patent application assigned Ser. No. 16/777,350 filed on Jan. 30, 2020, which is hereby incorporated by reference in its entirety, is employed to identify the location of the entity.

In one implementation where the additional item(s) extracted from the documents include a vendor identity, the combinations output include a vendor element. This can be accomplished by using an existing database of vendors and their products to automatically identify the vendor associated with a product listed in a combination. This information can be used in several advantageous ways. For example, the information can be used to determine whether a vendor's products are used entity-wide or just in particular functional areas. In addition, configurations involving at least the output of entity-functional area-product-location combinations can be modified to identify a vendor on an entity location basis. This information can be used to determine whether a vendor's products are used entity-wide or just in particular locations and functional areas.

In one implementation where the additional item(s) extracted from the documents include a technology designator, the combinations output include a technology designator element. This can be accomplished by using an existing database of technology designators and the products associated with each designator to automatically identify the technology designator associated with a product listed in a combination. It is noted that there can be a hierarchy of technology designators starting with the most general (e.g., Retail) and propagating down to more specific designators under the general designator (e.g., Home Improvement and Hardware retailer). This information can be used in several advantageous ways. For example, the information can be used to determine whether products associated with a particular technology have been adopted entity-wide or just in particular functional areas. In addition, configurations involving at least the output of entity-functional area-product-location combinations can be modified to identify a technology on an entity location basis. This information can be used to determine whether a technology has been adopted entity-wide or just in particular locations and functional areas.

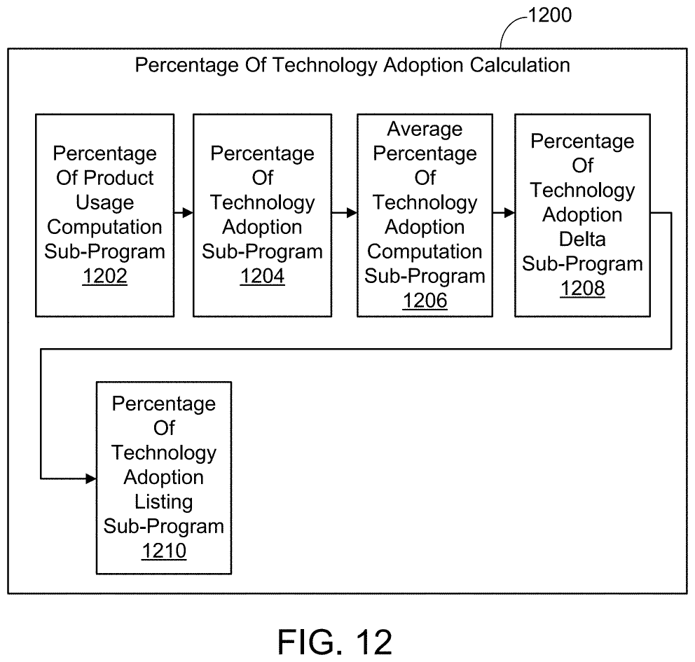

The percentages of the usage associated with each of the entity's functional areas of a technology can also be computed. If the percentages are calculated for multiple entities and then averaged across all the entities, this produces an average usage percentage for a technology in each functional area. A particular entity's usage percentage can then be compared to the average to determine if an entity's usage of a technology is above or below average. More particularly, referring to FIG. 12, in one implementation the entity functional area and product use identification computer program 1200 includes sub-programs to calculate a percentage of technology adoption. More particularly, in a percentage of product usage computation sub-program 1202, for each entity found in the listing of the established entity name-functional area-product name combinations and each listed functional area of the entity, a percentage of usage for a product listed in the functional area of the entity is computed. In one implementation, this computation involves dividing the summation of the number of entity name-functional area-product name combinations indicating the product is in use in the functional area by the summation of the number of entity name-functional area-product name combinations indicating the product is in use in any of the functional areas of the entity. Next, a percentage of technology adoption sub-program 1204 is employed to, for each of the established combinations, designate the percentage of usage for the product listed for the functional area of the entity in the established combination as the percentage of adoption of a technology associated with the technology designation listed for the functional area of the entity in the established combination. An average percentage of technology adoption computation sub-program 1206 is then employed to, for each of the same functional area across all the entities in the listing of the established combinations, compute an average of the percentages of technology adoption for a product across all the entities having the functional area. A percentage of technology adoption delta sub-program 1208 is employed next to compute whether the percentage of technology adoption for the functional area is above, or the same as, or below the average of the percentages of technology adoption for the functional area. A percentage of technology adoption listing sub-program 1210 is then used, for each entity found in the listing of the established combinations and each listed functional area of the entity, to output at least one of a listing of the percentage of adoption of the technology for the functional area, or a listing of the average percentage of adoption of the technology for the functional area, or a listing of whether the percentage of adoption of the technology for the functional area is above, or the same as, or below the average percentage of adoption of the technology for the functional area. The procedure illustrated in FIG. 12 can be repeated for each different product of interest.

In one implementation, any of the foregoing configurations can be output for a prescribed time period or periods, and a succession of time periods can be analyzed to identify trends. Analyzing the established combinations for an entity over time has many advantages. For example, in the implementation described previously where the percentages of the usage of a product across the entity's functional areas are calculated, doing this for sequential time periods can be used to determine if a product is being adopted over time across functional areas, thereby indicating a diversification of uses for the product within the entity. In implementations where an entity's location is also extracted from the documents, identifying the adoption of a product or technology over time at a particular location or identifying the diversification of a product over time to new locations can be useful for targeting sales and marketing efforts. Another advantageous use of the established combinations for an entity is determining the measure of sophistication exhibited by the entity's functional areas based on the type of products they have adopted. For instance, if a marketing department is using state of the art data analysis tools to analyze marketing data rather than rudimentary spreadsheet products, this is an indication of the department's sophistication and what new products they may be interested in adopting. Looking at this information over time also provides insight into when a functional area of an entity might be ready to adopt new products. For instance, if a department has just recently upgraded to a product, they may be less amenable to adopting a new product.

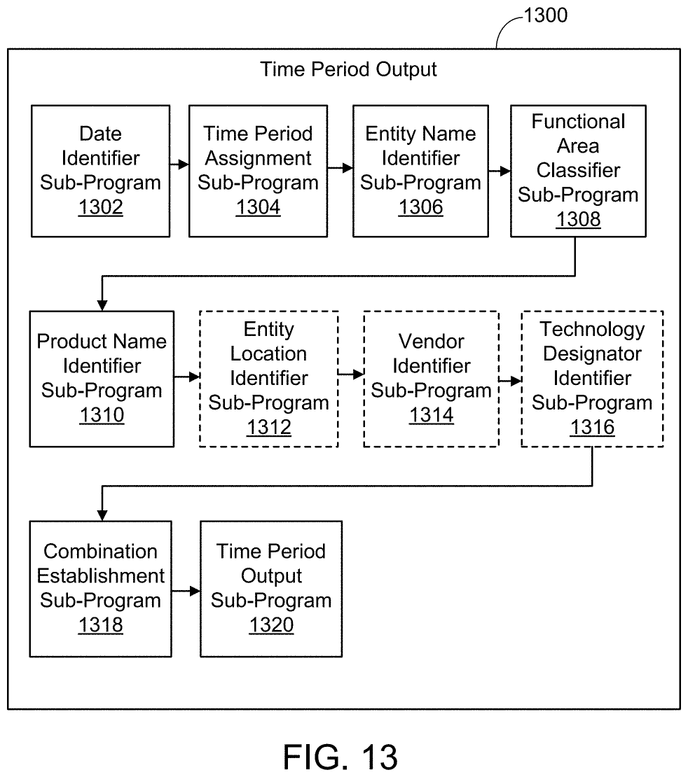

In general, outputting any of the foregoing configurations for a prescribed time period or periods, can be accomplished by inputting documents into the entity functional area and product use identification computer program implementations described herein that have assigned dates which fall within a particular time period, and repeating this process for other time periods of interest. More particularly, FIG. 13 illustrates one implementation of sub-programs included in the entity functional area and product use identification computer program 1300 that configure the previously described computing device or devices. First, for each document, a date identifier sub-program 1302 is employed to assign a date to the document. Next, a time period assignment sub-program 1304 assigns each document to a prescribed time period covering the date assigned to the document. An entity name identifier sub-program 1306 identifies an entity name for each document accessed, the functional area classifier sub-program 1308, for each document accessed, identifies a functional area of the entity that is inferred in the document, and the product name identifier sub-program 1310, for each document accessed, identifies one or more product names found in the document, as described previously. As also described previously, the computer program 1300 additionally employs at least one of an entity location identifier sub-program 1312 to identify a location associated with the entity name, or a vendor identifier sub-program 1314 to identify a vendor associated with each product name identified, or a technology designator identifier sub-program 1316 to identify a technology designation associated with each product name identified. The optional nature of sub-programs 1312, 1314, 1316 is indicated in FIG. 13 by the use of broken line boxes. A combination establishment sub-program 1318 then establishes, for each document accessed, combinations of the entity name, functional area, product name, and at least one of the entity location or the vendor of the named product or the technology designation of the product. A time period output sub-program 1320 is also included in the entity functional area and product use identification computer program 1300 to output a listing of the established combinations in groups according to the time period assigned to each combination.

With regard to the date identifier sub-program employed to assign a date to each document, in one implementation, a date identifier as described in a concurrently filed, commonly owned U.S. patent application assigned Ser. No. 16/777,350 filed on Jan. 30, 2020, which is hereby incorporated by reference in its entirety, is employed to identify a date associated with a document. Further, in one implementation, the date assigned to a document is a calendar date. Calendar dates can take various forms. For example, a calendar date can be a month/day/year or a month/year or a year. A date can also be in any format. Additionally, a calendar date can be a period of time (e.g., June 2018-December 2019 or 2017-2018, or 2018-present, and so on). Further, many different dates can be associated with a document, any of which can be assigned to the document. A date can be one that is extracted from the document itself, such as the date the author put in the document. The date can also be one connected with the document, such as the date that the document was published or submitted, or the date it was received, or the date it was entered into a database, among others. These dates might be found in metadata associated with the document.

### 3.0 Other Advantages and Implementations

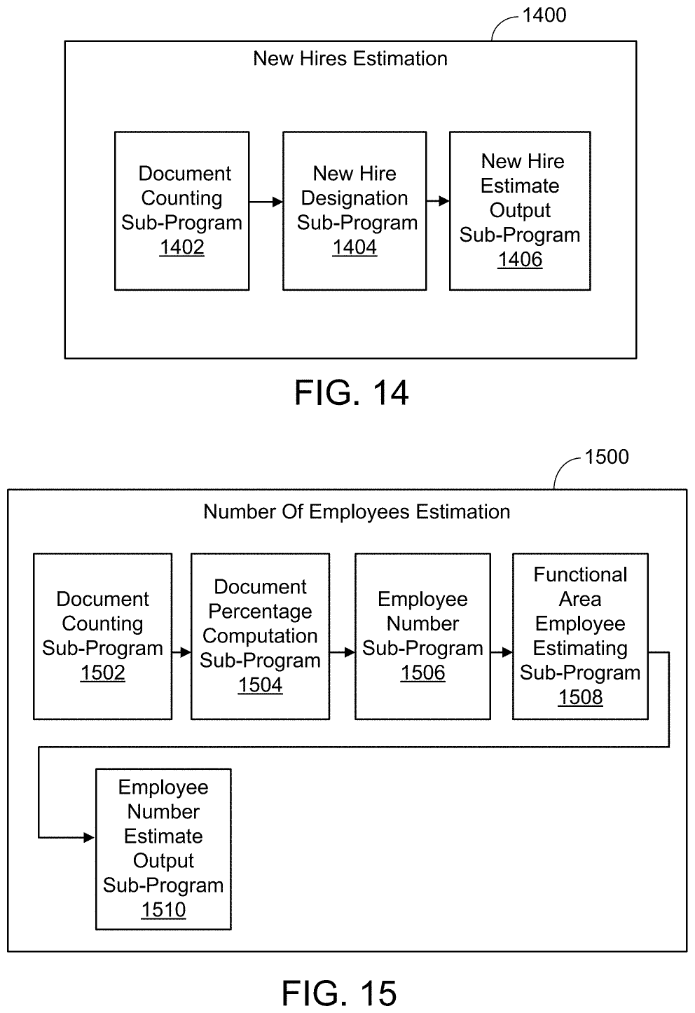

The previously described inputting of documents into the entity functional area and product use identification computer program implementations described herein that involve using job title and associated descriptions inputs can also be put to another advantageous use. Inputs to the functional area classifier can be considered as an indication of a position that will soon be filled. Thus, it is possible to estimate the number of new hires in a particular functional area of an entity based on the output of the computer program. The number of people being hired by a functional area of an entity and how this number changes over time can be useful information. For example, the number of individuals being hired into an entity's sales or engineering department, and how the numbers change over time, could indicate what an entity is focusing on. This in turn can indicate whether a functional area of an entity will be needing more or less of the products identified as being used by that functional area. More particularly, FIG. 14 illustrates one implementation of sub-programs included in the entity functional area and product use identification computer program 1400 that configure the previously described computing device or devices to estimate the number of new hires in a functional area of an entity. First, a document counting sub-program 1402 is employed to identify the number of documents associated with a same entity and functional area. A new hire designation sub-program 1404 then designates each document associated with said same entity and functional area to represent an imminent new hire. A new hire estimate output sub-program 1406 outputs the identified number of documents as an estimate of the number of new hires in the functional area of the entity. The foregoing process can be repeated for other entities and/or other functional areas.

In addition, it is possible to estimate the number of people associated with a functional area of an entity. This can indicate the size of the entity and its functional areas. Further, if this information is looked at over time, it is possible to infer if a company is growing or downsizing, among other things. Still further, the number of people working in a particular functional area and how this number changes over time can be useful information. For example, the number of individuals working for a company in sales or engineering, or programming, and how the numbers change over time could indicate what a company is focusing on. More particularly, FIG. 15 illustrates one implementation of sub-programs included in the entity functional area and product use identification computer program 1500 that configure the previously described computing device or devices to estimate the number of employees working in a functional area of an entity. First, a document counting sub-program 1502 is employed to identify the number of documents associated with a same entity and the number of documents associated with a functional area of the entity. A document percentage computation sub-program 1504 then computes a percentage of documents associated with the functional area. In one implementation, this computation involves dividing the number of documents associated with the functional area of the entity by the overall number of documents associated with the entity. Next, an employee number sub-program 1506 obtains the total number of employees working for the entity, and a functional area employee estimating sub-program 1508 multiplies the total number of employees working for the entity by the percentage of documents associated with the functional area to obtain an estimate of the number of employees working in the functional area of the entity. An employee number estimate output sub-program 1510 then outputs the estimated of the number of employees working in the functional area of the entity.

While the entity functional area and product use identification has been described by specific reference to implementations thereof, it is understood that variations and modifications thereof can be made without departing from the true spirit and scope. It is further noted that any or all of the implementations that are described in the present document and any or all of the implementations that are illustrated in the accompanying drawings may be used and thus claimed in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 4.0 Exemplary Operating Environments

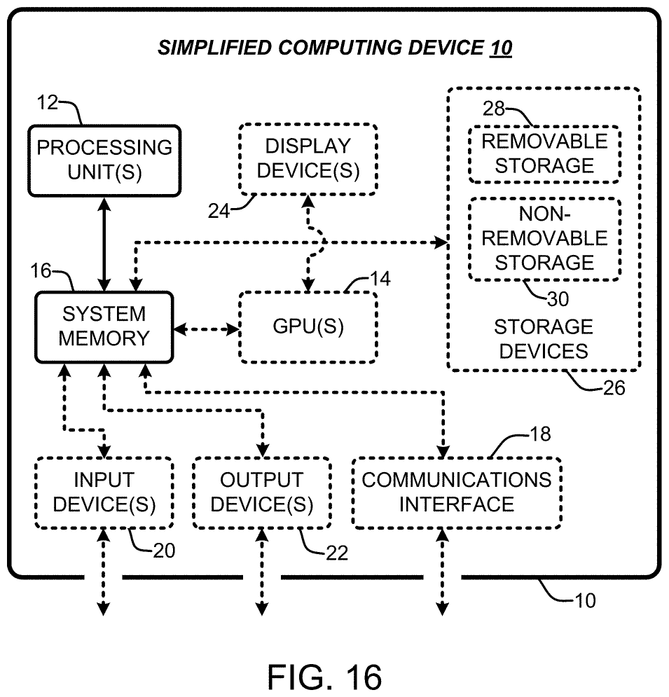

The entity functional area and product use identification implementations described herein are operational within numerous types of general purpose or special purpose computing system environments or configurations. FIG. 16 illustrates a simplified example of a general-purpose computer system on which various implementations and elements of the entity functional area and product use identification, as described herein, may be implemented. It is noted that any boxes that are represented by broken or dashed lines in the simplified computing device 10 shown in FIG. 16 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the entity functional area and product use identification implementations described herein, the device should have a sufficient computational capability and system memory to enable basic computational operations. In particular, the computational capability of the simplified computing device 10 shown in FIG. 16 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the entity functional area and product use identification implementations described herein, including input, output, control, feedback, and response to one or more users or other devices or systems associated with the entity functional area and product use identification implementations, are enabled by a variety of Natural User Interface (NUI) scenarios. The NUI techniques and scenarios enabled by the entity functional area and product use identification implementations include, but are not limited to, interface technologies that allow one or more users user to interact with the entity functional area and product use identification implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the entity functional area and product use identification implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the entity functional area and product use identification implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 16 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various entity functional area and product use identification implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The entity functional area and product use identification implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The entity functional area and product use identification implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor. Still further, the entity functional area and product use identification implementations described herein can be virtualized and realized as a virtual machine running on a computing device such as any of those described previously. In addition, multiple entity functional area and product use identification virtual machines can operate independently on the same computer device.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Wherefore, what is claimed is:

1. A system for identifying functional areas of an entity and products used by the functional areas, comprising:
an entity functional area and product use identifier comprising one or more computing devices, and an entity functional area and product use identification computer program having a plurality of sub-programs executable by said computing device or devices, wherein the sub-programs configure said computing device or devices to,
access documents that are likely to infer an entity's functional areas and list the products the functional areas employ,
for each document,
employ a functional area classifier to identify one or more functional areas of the entity inferred in the document,
employ a product name identifier to identity one or more product names found in the document,
establish at least one entity name-functional area-product name combination for each product name found in the document, and
output a listing of the established entity name-functional area-product name combinations.

2. The system of claim 1, wherein the documents comprise job listings that include job titles and job descriptions.

3. The system of claim 1, wherein the documents comprise job resumes that include job titles and job descriptions.

4. The system of claim 1, wherein the sub-program for employing a functional area classifier to identify a functional area of the entity inferred in the document, comprises employing a supervised machine learning technique which is trained using a plurality of input-output examples, said input of each input-output example comprising a job title and job description combination derived from a job listing or a job resume document and said output of each input-output example comprising a known entity functional area associated with the document used to derive the input, wherein the functional area classifier once trained comprises a functional area inferring function that identifies at least one functional area of the entity based on an input comprising a job title and job description combination derived from a job listing or a job resume document.

5. The system of claim 1, wherein the sub-program for employing a functional area classifier to identify at least one functional area of the entity inferred in the document, comprises employing an unsupervised machine learning technique which is trained to identify at least one functional area of the entity based on an input comprising a job title and job description combination derived from a job listing or a job resume document.

6. The system of claim 5, wherein the sub-program for employing a functional area classifier to identify at least one functional area of the entity inferred in the document, further comprises sub-programs for:
assigning probabilities to each possible functional area, which in total add up to 100 percent;
selecting the top three functional areas based on their probabilities;
whenever one of the selected functional areas has a probability that equals or exceeds 60%, choosing the selected functional area having a probability that equals or exceeds 60% as the sole functional area inferred by the document;
whenever none of the selected functional areas have a probability that equals or exceeds 60%, but one or more of the selected functional areas has a probability that equals or exceeds 40%, choosing the selected functional area or areas having a probability less than 60% but equal or exceeding 40% as the functional area or areas inferred by the document; and
whenever none of the selected functional areas have a probability that equals or exceeds 40%, deeming that no functional area is inferred by the document and eliminating the document from consideration in establishing entity name-functional area-product name combinations.

7. The system of claim 1, wherein the sub-program for employing a product name identifier to identity one or more product names found in the document, comprises limiting the product names identified to a prescribed list of products of interest.

8. The system of claim 1, wherein the entity functional area and product use identification computer program further comprises a sub-program for employing an entity name identifier to identity an entity name in the document.

9. The system of claim 1, wherein more than one functional area of the entity is inferred in the document, and wherein the sub-program for establishing at least one entity name-functional area-product name combination for each product name found in the document further comprises sub-programs for:
for each product identified in the document and each functional area inferred in the document, calculating the percentage of the documents being considered that are associated with the product and the functional area;
for each product identified in the document,
whenever one of the calculated percentages associated with the product equals or exceeds 90%, establishing a sole entity name-functional area-product name combination for the product comprising the functional area associated with the calculated percentage that equals or exceeds 90%; and
whenever none of the calculated percentages associated with the product equals or exceeds 90%,
adding the highest calculated percentages in order of magnitude that exceed a minimum percentage threshold, until the sum equals or exceeds 90% or all the percentages exceeding the minimum percentage threshold have been added together, and
establishing a separate entity name-functional area-product name combination for the product and each functional area associated with the calculated percentages used in the summation of percentages.

10. The system of claim 9, wherein the minimum percentage threshold calculated by dividing the integer 1 by the total number of functional areas.

11. The system of claim 1, wherein the entity functional area and product use identification computer program further comprises sub-programs for:
for each functional area across all the entities found in the listing of the established entity name-functional area-product name combinations, identifying all the products used in the functional area;
for corresponding functional areas between the entities, identifying products used in at least a prescribed percentage of the functional areas;
deeming the identified products used in at least the prescribed percentage of the functional areas as co-dependent products; and
outputting a list of co-dependent products for each functional area found in the listing of the established entity name-functional area-product name combinations.

12. The system of claim 1, wherein the entity functional area and product use identification computer program further comprises sub-programs that:
for each entity found in the listing of the established entity name-functional area-product name combinations and each listed functional area of the entity, computes a percentage of usage for a product listed in the functional area of the entity, said computation comprising dividing the summation of the number of entity name-functional area-product name combinations indicating the product is in use in the functional area by the summation of the number of entity name-functional area-product name combinations indicating the product is in use in any of the functional areas of the entity; and
for each entity found in the listing of the established entity name-functional area-product name combinations, outputs a listing of the percentage of usage for said product for each listed functional area of the entity.

13. The system of claim 12, wherein the entity functional area and product use identification computer program further comprises sub-programs that:
for each listed functional area found in the listing of the established entity name-functional area-product name combinations, computes an average of the percentages of usage for a product listed in the functional area across all the listed entities having the functional area in the listing of the established entity name-functional area-product name combinations to produce an average percentage of usage for the product; and
for each listed functional area, outputs a listing of average of the percentages of usage for said product.

14. The system of claim 13, wherein the entity functional area and product use identification computer program further comprises sub-programs that:
for each listed entity found in the listing of the established entity name-functional area-product name combinations and each listed functional area of the entity,
computes whether the percentage of usage for said product listed in the functional area is above, or the same as, or below the average of the percentages of usage for said product for the functional area across all the listed entities having the functional area in the listing of the established entity name-functional area-product name combinations, and
for each listed functional area, outputs a listing of whether the percentage of usage for said product listed in the functional area is above, or the same as, or below the average of the percentages of usage for said product in the functional area.

15. The system of claim 1, wherein the entity functional area and product use identification computer program further comprises sub-programs that:
for each entity found in the listing of the established entity name-functional area-product name combinations,
computes an entity-wide percentage of usage for a product listed as being used in any of the functional areas of the entity, said computation comprising dividing the summation of the number of entity name-functional area-product name combinations indicating the product is in use in any of the functional areas of an entity by the summation of the number of entity name-functional area-product name combinations indicating the product is in use in any of the functional areas of all the entities found in the listing of the established entity name-functional area-product name combinations, and
outputs a listing of the entity-wide percentage of usage for said product.

16. The system of claim 15, wherein the entity functional area and product use identification computer program further comprises sub-programs that:
computes an average of the entity-wide percentages of usage for said product across all the listed entities in the listing of the established entity name-functional area-product name combinations to produce an average entity-wide percentage of usage for a product, and
outputs the average of the entity-wide percentages of usage for said product.

17. The system of claim 16, wherein the entity functional area and product use identification computer program further comprises sub-programs that:
for each listed entity found in the listing of the established entity name-functional area-product name combinations,
computes whether the entity-wide percentage of usage for said product is above, or the same as, or below the average of the entity-wide percentages of usage for said product across all the listed entities in the listing of the established entity name-functional area-product name combinations, and
outputs a listing of whether the entity-wide percentage of usage for said product is above, or the same as, or below the average of the entity-wide percentages of usage for said product.

18. A computer-implemented process for identifying functional areas of an entity and products used by the functional areas, the process comprising the actions of:
using one or more computing devices to perform the following process actions, the computing devices being in communication with each other via a computer network whenever a plurality of computing devices is used:
accessing documents that are likely to infer an entity's functional areas and list the products the functional areas employ;
for each document,
employing a functional area classifier to identify one or more functional areas of the entity inferred in the document,
employing a product name identifier to identity one or more product names found in the document,
establishing at least one entity name-functional area-product name combination for each product name found in the document; and
outputting a listing of the established entity name-functional area-product name combinations.

19. A system for identifying functional areas of an entity and products used by the functional areas, comprising:
an entity functional area and product use identifier comprising one or more computing devices, and an entity functional area and product use identification computer program having a plurality of sub-programs executable by said computing device or devices, wherein the sub-programs configure said computing device or devices to,
access documents that are likely to infer an entity's functional areas and list the products the functional areas employ,
for each document,
employ an entity name identifier to identity an entity name in the document,
employ a functional area classifier to identify one or more functional areas of the entity inferred in the document,
employ a product name identifier to identity one or more product names found in the document,
employ at least one of an entity location identifier to identify a location associated with the entity name, or a vendor identifier to identify a vendor associated with each product name identified, or a technology designator identifier to identify a technology designation associated with each product name identified,
establish combinations of the entity name, functional area, product name, and at least one of the entity location or the vendor of the named product or the technology designation, and
output a listing of the established combinations.

20. The system of claim 19, wherein each of the established combinations comprises the technology designation of the named product, and wherein the entity functional area and product use identification computer program further comprises sub-programs that:
for each entity found in the listing of the established combinations and each listed functional area of the entity, computes a percentage of usage for a product listed for the functional area of the entity, said computation comprising dividing the summation of the number of established combinations indicating the product is in use in the functional area by the summation of the number of established combinations indicating the product is in use in any of the functional areas of the entity;
for each of the established combinations, designates the percentage of usage for the product listed for the functional area of the entity in the established combination as the percentage of adoption of a technology associated with the listed technology designation listed for the functional area of the entity in the established combination;
for each of the same functional area across all the entities in the listing of the established combinations, computes an average of the percentages of adoption of the technology to produce an average percentage of adoption of the technology for the functional area;
for each entity found in the listing of the established combinations and each listed functional area of the entity, computes whether the percentage of adoption of the technology for the functional area is above, or the same as, or below the average percentages of adoption of the technology for the functional area;
for each entity found in the listing of the established combinations and each listed functional area of the entity, outputs at least one of a listing of the percentage of adoption of the technology for the functional area, or a listing of the average percentage of adoption of the technology for the functional area, or a listing of whether the percentage of adoption of the technology for the functional area is above, or the same as, or below the average percentage of adoption of the technology for the functional area.

21. The system of claim 19, wherein the entity functional area and product use identification computer program further comprises sub-programs that:
for each document, employs a date identifier to assign a date to the document;
assigns each document to a prescribed time period covering the date assigned to the document; and wherein
the sub-program for outputting a listing of the established combinations, comprises outputting the established combinations in groups according to the time period assigned to each combination.

22. The system of claim 19, wherein the entity functional area and product use identification computer program further comprises sub-programs that:
identifies the number of documents associated with a same entity and functional area;
deems each document associated with said same entity and functional area to represent an imminent new hire; and
outputs the identified number of documents as an estimate of the number of new hires in said functional area of said entity.

23. The system of claim 19, wherein the entity functional area and product use identification computer program further comprises sub-programs that:
identifies the number of documents associated with a same entity;
identifies the number of documents associated with the same entity and a same functional area;
computes a percentage of documents associated with said functional area, the computation comprising dividing the number of documents associated with said same entity and said same functional area by the number of documents associated with said same entity;
obtains the total number of employees working for the entity;
multiplies the total number of employees working for the entity by the percentage of documents associated with said functional area to obtain an estimate of the number of employees working in said functional area of said entity; and
outputs the estimated of the number of employees working in said functional area of said entity.
